(19) United States
(12) Patent Application Publication
(10) Pub. No.: US 2014/0059488 A1
(43) Pub. Date: Feb. 27, 2014

(54) SYSTEM AND METHOD FOR VIEWING SELECTED DESCENDANT NODES IN A TREE HIERARCHY DISPLAYED IN TABULAR FORM

(71) Applicants: Mohannad El-Jayousi, L'lle Bizard (CA); Xuebo Liang, Brossard (CA); Kedar Shiroor, Mountain VIew, CA (US); Rolan Abdukalykov, Montreal (CA); Alain Gauthier, Montreal (CA); Vincent Lavoie, Montreal (CA); Roy Ghorayeb, Montreal (CA)

(72) Inventors: Mohannad El-Jayousi, L'lle Bizard (CA); Xuebo Liang, Brossard (CA); Kedar Shiroor, Mountain VIew, CA (US); Rolan Abdukalykov, Montreal (CA); Alain Gauthier, Montreal (CA); Vincent Lavoie, Montreal (CA); Roy Ghorayeb, Montreal (CA)

(73) Assignee: SAP AG, Walldorf (DE)

(21) Appl. No.: 13/590,868

(22) Filed: Aug. 21, 2012

(51) Int. Cl. G06F 17/30

(52) U.S. Cl. 715/823

(57) ABSTRACT

A system, method, and computer program product for automatically summarizing selections in a hierarchical data tree. Embodiments display a table with at least one entry, corresponding to a level of a branch of a tree, representing a node and comprising a node descriptor, a node selection status indicator, and a summary of selected descendant nodes present. A user may toggle a node selection status via the node selection status indicator, which visually denotes a node selection status is one of selected, unselected, and mixed, according to the number of selected descendant nodes present. The summary of selected descendant nodes comprises a list of descendant node descriptors that summarize an ordered set of nodes between a current node and a lowest level selected node. Either navigation to an entry or modification of a node selection status triggers a propagation of node property updates.

### BACKGROUND

The present invention relates to visualizing and navigating a tree hierarchy displayed in a graphical user interface in tabular form, and in particular to rapidly determining which nodes in the tree have been selected.

Many instances may arise in which a user of a computing device wishes to rapidly view and navigate a hierarchical tree of information. The user may wish to view information available at various portions of the tree, view which portions of the tree have been previously selected, and/or make new selections. For example, software applications may have numerous options with default settings that are available for customization by a user, and these may be detailed in a hierarchical tree. Likewise, a user may wish to select portions of a large dataset in an enterprise resource planning application.

Displaying an entire hierarchical tree may not always be an option. In some instances the tree is simply too large to allow for convenient display. For example, a display device may be of limited size and resolution, which is often the case with mobile computing devices such as personal digital assistants (PDAs) and smartphones. The tree is therefore often presented in tabular form, one column at a time, with each column representing a level of a given branch in the hierarchy.

Unfortunately, this pull-down menu type tabular representation of the tree hinders the user's ability to get a complete picture of the selection criteria for the various selected nodes of the tree. The user of a conventional tree display has to navigate in and out of each branch, level by level, to be able to get a full picture of the tree and of its selected nodes. Further, the user may simply not be able to easily maintain context when navigating within a hierarchical tree of significant breadth and depth.

Therefore, an improved system and method for visualizing and navigating a hierarchical data tree is needed.

### BRIEF DESCRIPTION OF THE DRAWINGS

FIG. 1A is a diagram of an exemplary hierarchical data tree.

FIG. 1B is a diagram of an exemplary lowest level branch in a hierarchical data tree, depicting selected and unselected leaf nodes and node descriptors, according to an aspect of the present invention.

FIG. 2 is a diagram of an exemplary second level branch in a hierarchical data tree, depicting two intermediate nodes including a mixed node, and a descendant summary, according to an aspect of the present invention.

FIG. 3 is a diagram of an exemplary third level branch in the hierarchical data tree, depicting two intermediate nodes including a mixed node, and a descendant summary, according to an aspect of the present invention.

FIG. 4 is a diagram of an exemplary fourth level branch in the hierarchical data tree, depicting a mixed node and a descendant summary, according to an aspect of the present invention.

FIG. 5 is a diagram of an exemplary root level branch in the hierarchical data tree, depicting a selected node, an unselected node, a mixed node, and a truncated descendant summary, according to an aspect of the present invention.

FIG. 6 is a diagram of an exemplary computer system, according to an aspect of the present invention.

FIG. 7 is a flowchart describing an exemplary hierarchical data tree updating algorithm, according to an aspect of the present invention.

### DETAILED DESCRIPTION

As described more fully below, the embodiments disclosed permit improved visualization and navigation of a data tree hierarchy. Embodiments of the invention provide control algorithms to manage a display and user interface within a computer system such as, for example, a mobile computing device. The user interface may call for display of an n-level selection tree hierarchy, which may be presented in tabular form, one column at a time, with each column representing a level of a given branch in the hierarchy.

The selection tree hierarchy may include a root node with n child nodes, and each child node may have a number of children. Thus, the hierarchy may have a number of levels determined by application requirements for which the hierarchy will be used. Each of these nodes may have a descriptor, a status indicator, and a descendant summary, and may be considered a superset of all descendant nodes.

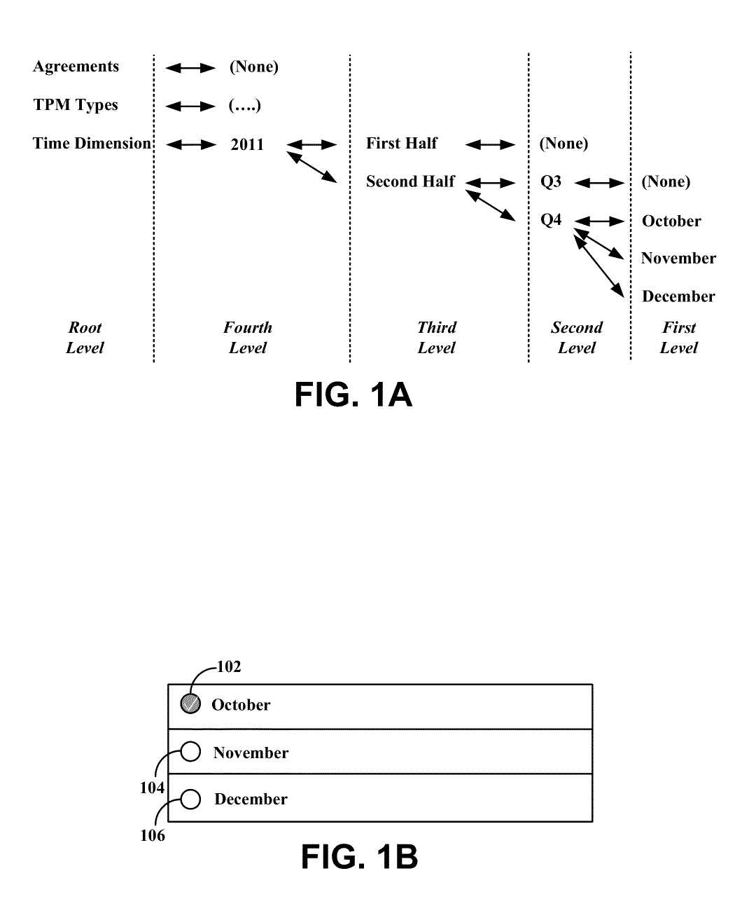

Referring now to FIG. 1A, a diagram is shown of an exemplary hierarchical data tree. The tree has a root level and a number of branches, each of which terminate in at least one leaf node. The branches may correspond to a variety of schemes for dividing data, such as by person, product or, as shown in this example, a date range. Each branch may comprise a number of distinct levels denoting further data division. Eventually, each branch ends in a leaf node. A user may view such a tree to select subsets of data to be further processed. Details of each level are now provided.

Referring now to FIG. 1B, a diagram is shown of an exemplary lowest level branch in a hierarchical selection data tree, depicting selected leaf node 102 and unselected leaf nodes 104 and 106. Corresponding node descriptors, in this case various months of the year, may also be displayed. According to embodiments of the present invention, each hierarchy node in the tree may have three possible defined statuses: “selected,” “unselected,” and “mixed”.

When the status of a node is selected, as with leaf node 102 for “October” data, all its descendant nodes may also be set to selected status. In this application, selected nodes are indicated with a solid circle that includes a check mark, but other indicia may be used, including variously colored or shaped indicia. If a node is not selected, and none of its descendant nodes are selected, the node may have an unselected status, depicted in this application with an exemplary open circle as shown for the “November” and “December” data. If a node is not selected, but any descendant node in the node's branch is selected, the node may have a mixed status, to be described.

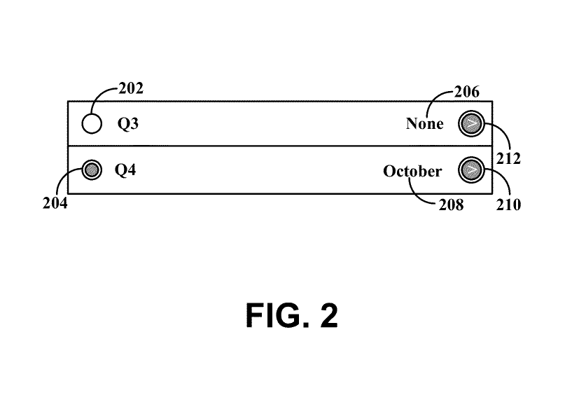

Referring now to FIG. 2, a diagram is shown of an exemplary second level branch in the hierarchical data tree, i.e., this is the level just above the level with the leaf nodes depicted in FIG. 1. In this example, this level includes two intermediate nodes including an unselected node 202 for “Q3” data, and a mixed node 204 for “Q4” data. Mixed nodes are depicted in this application with a small solid circle within an open circle, though again this is only an exemplary indicator type. Other icons and/or colors may be used to indicate mixed nodes. Node 204 is mixed because the displayed node is an unselected node but one of its children is a selected node, in this case the “October” node, item 102. In other words, Q4 is the parent node of the October node. The mixed status and corresponding indicator help a user determine immediately that there is at least one selected node somewhere among node 204's descendant nodes.

Descendant summaries 206 and 208 may provide displayed text fields that help the user visualize the descendant nodes without requiring actual navigation to them. When visiting a node, the descendant summary may be “All” for selected nodes, and “None” for unselected nodes for clarity. Descent summary 206, “None”, for example, may denote that none of the descendants of “Q3” data are currently selected. Descendant summary 208, “October” may specify which of the descendants of “Q4” data are selected; in this case an immediate descendant is selected, but the embodiments are not so limited, as will be further described. Descendant links 210 and 212 may be provided to enable immediate user navigation to lower levels of the hierarchy; in other words, a user could navigate to the FIG. 1 display by selecting descendant link 210.

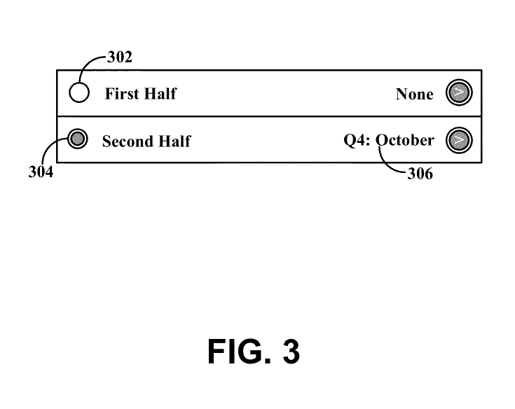

Referring now to FIG. 3, a diagram of an exemplary third level branch in the hierarchical data tree is shown, depicting two intermediate nodes including an unselected node 302 “First Half”, a mixed node 304 “Second Half”, referring to the first and second halves of a year, and a descendant summary 306 “Q4: October”. This branch is just above the branch depicted in FIG. 2, previously described. In this case, descendant summary 306 “Q4: October” immediately communicates to a user that the particular selected node that renders node 304 mixed is two levels down, i.e. one step down in “Q4” data, then another step down within “Q4” data to “October” data.

The descendant summary is generally a list of the descriptors of all descendant nodes with selected status. The descendant summary also encompasses all mixed status nodes between the current node and the selected node. Thus, the embodiments of the present invention enable visualization of the contents of multiple hierarchy levels without requiring potentially confusing navigation actions to determine which are the selected nodes. The embodiments may use a colon and a space as a separator for the multiple node descriptors in descendant summaries describing the descendants of mixed nodes, while the descriptors of selected status branches may be separated by commas and spaces. Navigation links may be again provided to descend into the tree if desired.

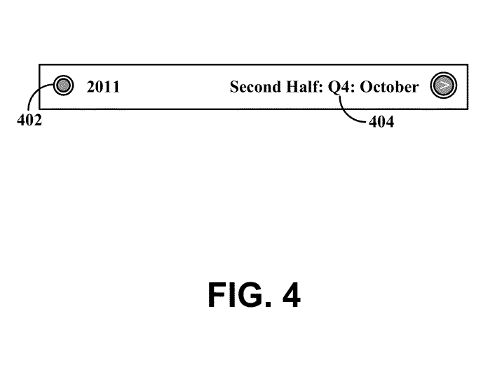

Referring now to FIG. 4, an exemplary fourth level branch in the hierarchical data tree is shown in a diagram depicting a mixed node 402 labeled “2011” to refer to a year, and a descendant summary 404 “Second Half: Q4: October”. This branch is just above that of FIG. 3, i.e., selection of the navigation link would display FIG. 3. In this case, descendant summary 404 spans three levels to identify the selected node that renders node 402 a mixed node. While navigation links may again be provided, they are not required for clear visualization of the branch by a user.

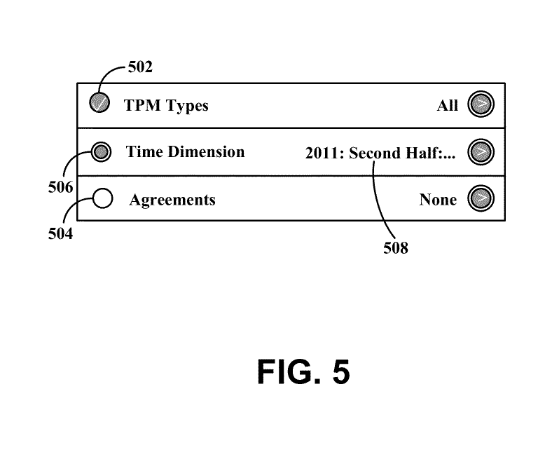

Referring now to FIG. 5, a diagram of an exemplary root level branch in the hierarchical data tree is shown, depicting a selected node 502 “TPM Types”, an unselected node 504 “Agreements”, a mixed node 506 “Time Dimension” and a corresponding truncated descendant summary 508 “2011: Second Half: . . . ”. In this instance, descendant summary 508 is truncated because a full descendant summary will not fit in the column, given a particular selected font size and the number of characters involved. So, a truncated summary is provided showing the most immediate members of the list of nodes leading to the selected node, with an ellipsis indicating that further undisplayed levels exist. A user defined option may also limit the number of levels described in a descendant summary. Navigation links are again provided for user exploration of the tree.

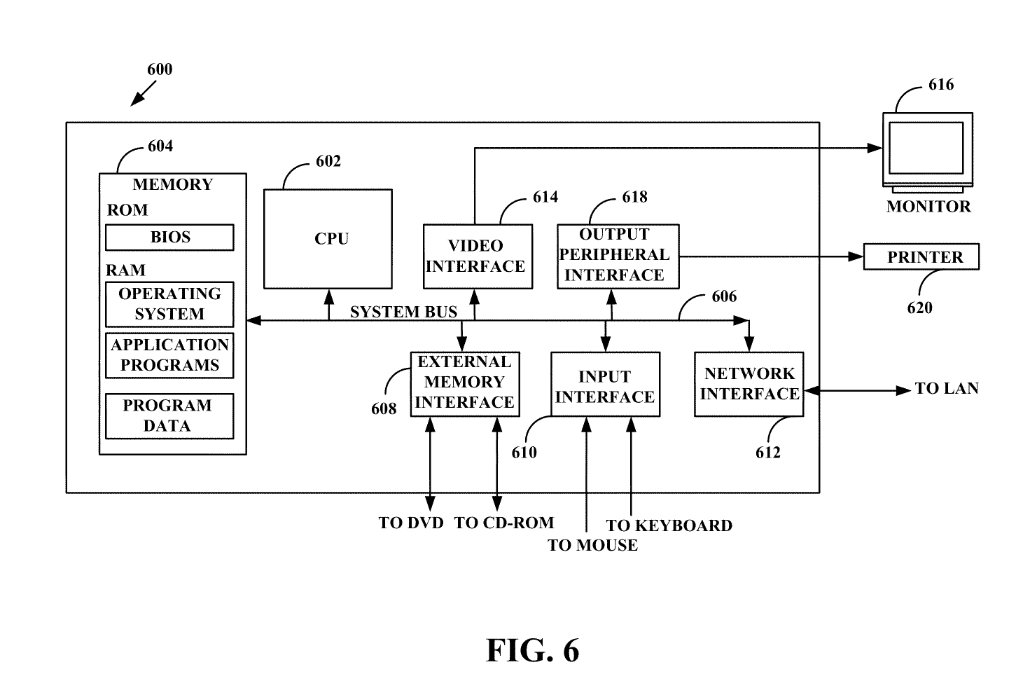

Referring now to FIG. 6, a computer system is depicted comprising an exemplary structure for implementation of the embodiments described above. Computer system 600 comprises a central processing unit (CPU) 602 that processes data stored in memory 604 exchanged via system bus 606. Memory 604 may include includes read-only memory, such as a built-in operating system, and random-access memory, which may include an operating system, application programs, and program data. Computer system 600 may also comprise an external memory interface 608 to exchange data with a DVD or CD-ROM for example. Further, input interface 610 may serve to receive input from user input devices including but not limited to a keyboard, a mouse, or a touchscreen (not shown). Network interface 612 may allow external data exchange with a local area network (LAN) or other network, including the internet. Computer system 600 may also comprise a video interface 614 for displaying information to a user via a monitor 616 or a touchscreen (not shown). An output peripheral interface 618 may output computational results and other information to optional output devices including but not limited to a printer 620 for example via an infrared or other wireless link.

Computer system 600 may comprise a mobile computing device such as a personal digital assistant or smartphone for example, along with software products for performing computing tasks. The computer system of FIG. 6 may for example receive program instructions, whether from existing software products or from embodiments of the present invention, via a computer program product and/or a network link to an external site.

The embodiments of the present invention give the user a clear overview of a selection tree when it is displayed in tabular form, as described above. The initial generation and any updating of the displayed data may be performed by a processor executing program instructions to update a node's status based on an ancestor's status, and therefore may affect the summary property of all ancestor and descendant nodes in the entire branch. For large trees, the updating process may become computationally expensive. Methods of optimizing the performance of the descendant summary calculation, and the propagation of a hierarchy node status toggling are therefore provided below.

### Building the Tree

To efficiently traverse the tree, each node may provide a pointer to its only parent, and an array of pointers to any children it may have. The children array hence may be empty for leaf nodes, and the root node may have a null pointer for the parent property. The tree may be initially provided in the form of a table of selection criteria, with each row having a parent ID property. To build the tree, embodiments of the present invention, such as a processor executing program instructions from an operating system or an application program and storing information about the tree in a data structure in a memory for example, may exploit this property and proceed as follows:

For each selection criteria row:

A) Create the instance of the node in memory.

B) If the parent ID property is not null, look up the parent node instance and set a pointer to it as a property of the current node.

C) When in possession of the parent node, add a pointer of the current node to the array of children in the parent.

Note that the calculation-intensive summary building operation may be deferred until it is needed, i.e., when a node is visited and displayed for example, which may conserve computer system resources. When a node's status is modified, this action may affect all descendants and ancestors in terms of both status and summary. Calculating the status and descendant summary may be computationally expensive considering that those operations are dependent on the various statuses of descendants and ancestors. The status propagation may also be performed by a computer system using a deferral policy, and thus calculated on demand. Nevertheless, an up-to-date summary of all selected descendant nodes should be provided by the computer system when visiting a node, or modifying its status, regardless of how many levels apart the descendant node is from the current node. Different algorithms are thus provided for the computer system, to avoid iterating over a node's ancestors where feasible for efficiency purposes.

### Deferred Status Propagation

When the computer system is changing a node's status, the propagation of that status change may be efficiently performed by visiting the descendant nodes only, using a recursive method. Ancestor nodes may be left out-of-date until they are visited by the processor, to increase the efficiency of the algorithm executed by the processor, as follows:

When the user visits a node or modifies its status:

A) If the visited node is not a leaf, visit each child and set its status to the one its parent has.

B) Repeat step A recursively until reaching a leaf node. On-the-fly status propagation

If performance optimization is not a concern, an alternate embodiment may also keep the entire selection tree up-to-date at all times by directing the processor as follows:

First, perform all steps described for descendant traversal in the previous section on deferred status propagation.

Next, if the visited node has a parent, go over the parent's children array and count the number of selected, unselected and mixed status nodes. If the selected status count is equal to the children count, the parent status is selected. If the unselected status count is equal to the children count, the parent status is unselected. Otherwise, it has mixed status.

Then, repeat the previous step recursively until reaching the root node.

### Deferred Summary Calculation

Nodes with “mixed” status have an interesting descendant summary, which is calculated by the computer system by traversing all descendant nodes using the following recursive method:

For each child of the current node:

A) If the status of the node is checked, append its descriptor to the descendant summary string (preceded by a comma and space if not the first of the current level).

B) Else, if the status of the node is mixed, append its descriptor, followed by a colon and a space, followed by its own descendant summary which is calculated by recursively performing this algorithm (preceded by a comma and a space if not the first of the current level).

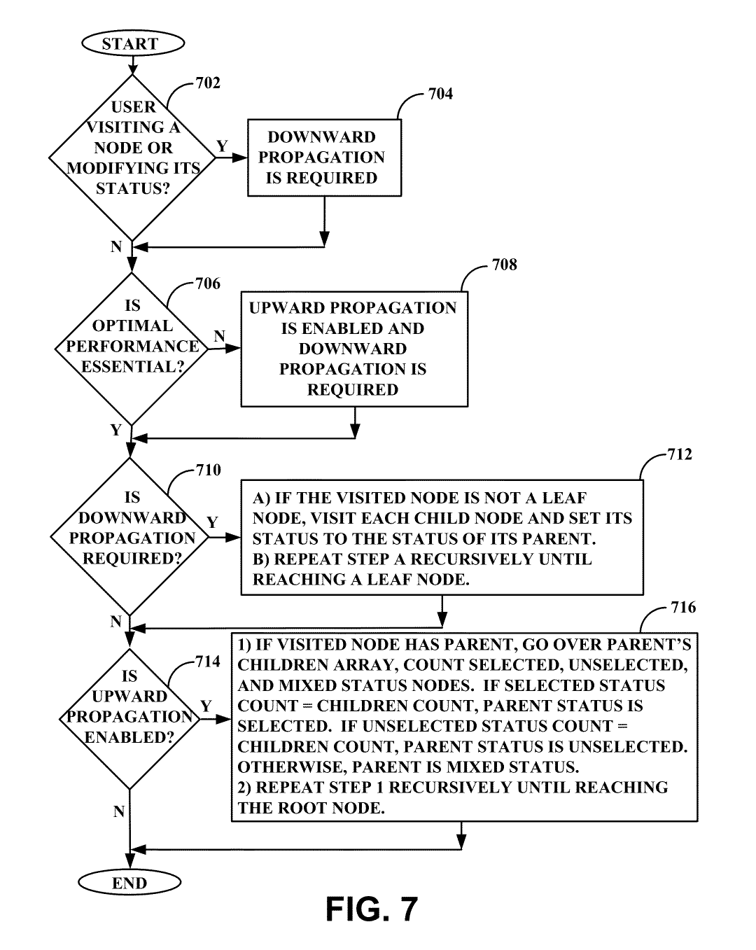

Referring now to FIG. 7, a flowchart of the exemplary programmed operation of computer system 600 is depicted according to an embodiment of the present invention. First, in step 702, the computer system determines if a user is visiting a node or modifying its status, e.g. by selecting or deselecting the node. If so, then a flag may be set in step 704 denoting that downward propagation is required of the node's status to its descendants. Next, in step 706, the computer system determines if a performance optimization mode has been engaged. If not, then in step 708 a flag may be set denoting that upward propagation is enabled, so that all nodes above the current node in the tree may be updated. A flag may also be set denoting that downward propagation of the node's status to its descendants may be performed. Next, in step 710 the computer system determines if downward propagation should be performed, according to previous analyses. If so, then in step 712 the computer system performs the downward propagation as previously described under deferred status propagation. Then, in step 714, the computer system determines if upward propagation has been enabled, i.e., because the performance optimization mode has not been engaged, the entire tree may be kept updated. If so, then in step 716 the computer system performs upward propagation as previously described under on-the-fly status propagation. Deferred summary calculation is also performed (not shown) by the computer system.

To summarize, a system, method, and computer program product for automatically summarizing selections in a hierarchical data tree are provided. Embodiments may display a table with at least one entry, corresponding to a level of at least one branch of a hierarchical data tree, with each entry representing a node and comprising a node descriptor, a node selection status indicator, and a summary of selected descendant nodes present, and may selectively toggle a node selection status according to user interaction with the node selection status indicator. The node selection status indicator may visually denote a node selection status as one of selected, unselected, and mixed, according to the number of selected descendant nodes present.

The summary of selected descendant nodes may comprise a list of descendant node descriptors and separator characters that summarize an ordered set of nodes between a current node and a lowest level selected node. A navigation link that enables display of a second entry representing a descendant node may also be provided. Either navigation to an entry or modification of a node selection status may trigger a propagation of node property updates, including node selection status and summary calculation, to descendant nodes. A similar propagation of node property updates to ancestor nodes may be performed if optimal performance is not selected.

Other embodiments may also include a computer program product having machine-readable executable program instructions thereon to direct a processor to perform the method steps, for example, as well as a computer system that executes instructions to carry out the method steps described.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation. The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

In accordance with the practices of persons skilled in the art of computer programming, embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The non-transitory code segments may be stored in a processor readable medium or computer readable medium, which may include any medium that may store or transfer information. Examples of such media include an electronic circuit, a semiconductor memory device, a read-only memory (ROM), a flash memory or other non-volatile memory, a floppy diskette, a CD-ROM, an optical disk, a hard disk, a fiber optic medium, etc. User input may include any combination of a keyboard, mouse, touch screen, voice command input, etc. User input may similarly be used to direct a browser application executing on a user's computing device to one or more network resources, such as web pages, from which computing resources may be accessed.

While particular embodiments of the present invention have been described, it is to be understood that various different modifications within the scope and spirit of the invention are possible. The invention is limited only by the scope of the appended claims.

What is claimed is:

1. A computer-implemented method for summarizing selections in a hierarchical data tree, comprising:
displaying a table with at least one entry, corresponding to a level of at least one branch of a hierarchical data tree, with each entry representing a node and comprising a node descriptor, a node selection status indicator, and a summary of selected descendant nodes present; and
selectively toggling a node selection status according to user interaction with the node selection status indicator.

2. The method of claim 1 wherein the table comprises a single column with at least one row.

3. The method of claim 1 wherein the node descriptor comprises a text field.

4. The method of claim 1 wherein the node selection status indicator visually denotes a node selection status is one of selected, unselected, and mixed, according to a number of selected descendant nodes present.

5. The method of claim 4 wherein the selection status indicator visually denotes the node selection status using at least one of: shape, shading, color, and marking.

6. The method of claim 1 wherein the summary of selected descendant nodes comprises a list of descendant node descriptors and separator characters that summarize an ordered set of nodes between a current node and a lowest level selected node.

7. The method of claim 1 wherein the entry further comprises a navigation link that enables display of a second entry representing a descendant node upon navigation link activation.

8. The method of claim 1 wherein at least one of navigation to an entry and modification of a node selection status triggers a propagation of node property updates, including node selection status and summary calculation, to descendant nodes.

9. The method of claim 1 wherein a predetermined election that optimal performance is not essential triggers a propagation of node property updates, including node selection status and summary calculation, to ancestor nodes.

10. A non-transitory computer readable medium storing instructions that, when executed by a processor, perform a method for summarizing selections in a hierarchical data tree, the method comprising:
displaying a table with at least one entry, corresponding to a level of at least one branch of a hierarchical data tree, with each entry representing a node and comprising a node descriptor, a node selection status indicator, and a summary of selected descendant nodes present; and
selectively toggling a node selection status according to user interaction with the node selection status indicator.

11. The computer readable medium of claim 10 wherein the table comprises a single column with at least one row.

12. The computer readable medium of claim 10 wherein the node descriptor comprises a text field.

13. The computer readable medium of claim 10 wherein the node selection status indicator visually denotes a node selection status is one of selected, unselected, and mixed, according to a number of selected descendant nodes present.

14. The computer readable medium of claim 13 wherein the selection status indicator visually denotes the node selection status using at least one of: shape, shading, color, and marking.

15. The computer readable medium of claim 10 wherein the summary of selected descendant nodes comprises a list of descendant node descriptors and separator characters that summarize an ordered set of nodes between a current node and a lowest level selected node.

16. The computer readable medium of claim 10 wherein the entry further comprises a navigation link that enables display of a second entry representing a descendant node upon navigation link activation.

17. The computer readable medium of claim 10 wherein at least one of navigation to an entry and modification of a node selection status triggers a propagation of node property updates, including node selection status and summary calculation, to descendant nodes.

18. The computer readable medium of claim 10 wherein a predetermined election that optimal performance is not essential triggers a propagation of node property updates, including node selection status and summary calculation, to ancestor nodes.

19. A system for summarizing selections in a hierarchical data tree, comprising:
a processor executing instructions to:
display a table with at least one entry, corresponding to a level of at least one branch of a hierarchical data tree, with each entry representing a node and comprising a node descriptor, a node selection status indicator, and a summary of selected descendant nodes present; and
selectively toggling a node selection status according to user interaction with the node selection status indicator.

20. A system for summarizing selections in a hierarchical data tree, comprising:
means for displaying a table with at least one entry, corresponding to a level of at least one branch of a hierarchical data tree, with each entry representing a node and comprising a node descriptor, a node selection status indicator, and a summary of selected descendant nodes present; and
means for selectively toggling a node selection status according to user interaction with the node selection status indicator.

21. A computer-implemented method for summarizing selections in a hierarchical data tree, comprising:
building an initial hierarchical data tree in a memory by, for each selection criteria row:
creating an instance of a node in a memory;
if a parent ID property of the node is not null, looking up a parent node instance in the memory and setting a pointer to it as a property of the node;
adding a node pointer to an array of children in the parent node;
determining a node status by:
a) if the node is not a leaf node, visiting each child and setting its status to its parent's status; and
b) repeating step a) recursively until reaching the leaf node; and
displaying a table with at least one entry, corresponding to a level of at least one branch of the hierarchical data tree, with each entry representing the node and comprising a node descriptor, a node selection status indicator, and a summary of selected descendant nodes present.

22. A computer-implemented method for summarizing selections in a hierarchical data tree, comprising:
building an initial hierarchical data tree in a memory; and
according to user interaction with a node selection status indicator:
toggling a node selection status; and
propagating node property updates to descendant nodes by, for each descendant node:
a) setting its status to its parent's status; and
b) repeating step a) recursively until reaching a leaf node; and
displaying a table with at least one entry, corresponding to a level of at least one branch of the hierarchical data tree, with each entry representing a node and comprising a node descriptor, the node selection status indicator, and a summary of selected descendant nodes present.
